(19) United States
(12) Patent Application Publication
(10) Pub. No.: US 2011/0195342 A1
(43) Pub. Date: Aug. 11, 2011

(54) SOLID OXIDE FUEL CELL REACTOR

(75) Inventors: Jing-li Luo, Edmonton (CA); Xian-zhu Fu, Edmonton (CA); Nemanja Danilovic, Edmonton (CA); Karl T. Chuang, Edmonton (CA); Alan R. Sanger, Edmonton (CA)

(73) Assignee: THE GOVERNORS OF THE UNIVERSITY OF ALBERTA, Edmonton (CA)

(21) Appl. No.: 12/903,063

(22) Filed: Oct. 12, 2010

Related U.S. Application Data
(60) Provisional application No. 61/302,881, filed on Feb. 9, 2010.

(51) Int. Cl. H01M 8/10

(52) U.S. Cl. 429/495; 429/535

(57) ABSTRACT

An integral ceramic membrane for a fuel cell is provided, with a non-porous layer and porous layers both formed of proton conducting material. The proton-conducting material may be a compound or mixture of compounds of the formula X1-X2-O_{3-δ} where X1=Ba, Sr or mixtures thereof and X2=Ce, Zr, Y, Nd, Yb, Sm, La, Hf, Pr or mixtures thereof. The combined atomic ratio of Y, Nd, Yb, Sm and La to Ba and Sr may in an embodiment be between 0.1 and 0.3 inclusive.

### CROSS-REFERENCE TO RELATED APPLICATIONS

This application claims the benefit under 35 USC 119(e) of U.S. provisional application 61/302,881 filed Feb. 9, 2010, the entire disclosure of which is herein incorporated by reference.

### BACKGROUND

Solid oxide fuel cells (SOFC) commonly use an oxygen ion conducting electrolyte which conducts oxygen ions from the oxygen side of the cell to the hydrocarbon side of the cell where they oxidize the hydrocarbon, typically completely into carbon dioxide and water. However, hydrocarbons also are important feedstock for the chemical industry. For example, ethylene, which usually is obtained via steam cracking of ethane, is a major intermediate for production of polymers [4]. To more efficiently utilize ethane resources and reduce emissions of green house gases including CO₂, an alternative SOFC reactor with proton conducting electrolyte has been conceived for co-generation of electrical energy and ethylene with high selectivity [5, 6].

Ethylene is a major intermediate in the petrochemicals industry. Currently, it is most economically produced by steam cracking of ethane. However, in this process more than 10% of ethane feed is oxidized to CO₂, and NOx pollutant also is produced [4]. Alternative methods, in particular oxidative dehydrogenation of ethane to ethylene, have been intensively researched in recent years [25]. In each case, during oxidative dehydrogenation a significant amount of ethane unavoidably is deeply oxidized to CO₂ and the chemical energy from conversion of hydrogen is not recovered as high grade energy. Further, oxidative methods also produce acetylene, which is very detrimental to manufacture of polymers as it poisons the catalysts and so must be removed to form high purity ethylene feed, an expensive process [24]. In contrast, electrochemical conversion of ethane using proton conducting solid oxide fuel cells (SOFCs) is potentially more selective, allows recovery of high grade energy, and generates little or no pollutants [5, 26].

In a solid oxide fuel cell, it is desirable that the electrolyte layer be thin in order to minimize the resistance to the flow of the species of ions that is desired to be transported across the membrane. However, a thin electrolyte layer by itself lacks sufficient mechanical strength, so it is desirable to support the electrolyte layer with a thicker electrode layer on at least one side. Conventionally the electrode layer and electrolyte layer are made of different materials, which results in resistance to flow of ions between the layers.

During fabrication of membrane electrode assemblies (MEA) of SOFC, it is usually necessary to form composite electrodes by mixing electrolyte material and catalysts, and then sinter the MEA at high temperature so as to enhance the triple phase boundary (TPB) and adhesion between layers of the MEA. High conductivity proton conducting electrolytes for SOFC are important for good transport of protons from anode to cathode and enabling electrical power output. Rapid removal of the protons enhances ethane dehydrogenation conversion. Among oxide proton conductors, doped BaCeO_{3-δ} perovskites display almost highest proton conductivity at elevated temperature [7, 27], particularly when co-doped with Y and Nd [28], or Y alone [7]. However, their sintering temperatures also are high, typically at least 1400° C., which may compromise many potential catalysts, or may effect a deleterious reaction between catalyst and electrolyte. To improve the performance of conventional proton conducting thin film electrolyte supported by single composite electrodes by reducing the ohmic resistance arising from the proton conducting electrolyte, Ni-based anode supported thin film electrolytes have been used widely for fabrication of H₂ SOFCs, and the anode substrates for these SOFC commonly are cermets prepared by sintering mixtures of NiO and electrolyte materials at high temperatures [8-15]. Unfortunately, Ni is not appropriate for use as anode catalyst in hydrocarbon SOFC since it has high propensity to form coke [16], thus deteriorating performance. Moreover, conventional proton conducting thin film electrolyte supported by single composite electrodes typically are prepared by high temperature sintering of a mixture of NiO and electrolyte material to form a cermet [8, 12, 27, 29]. Unfortunately, such conventional MEA are not suitable for use in hydrocarbon SOFCs as the Ni anode is prone to severe coking, thus deteriorating performance [30]. Furthermore, the potential range of alternative materials used as anode catalysts might be limited by the high temperatures required for preparation of cermets for use with impure H₂ fuels.

### SUMMARY

An integral ceramic membrane for a fuel cell is provided, with a non-porous layer and porous layers both formed of proton conducting material. In an embodiment, the proton-conducting material may be a compound or mixture of compounds of the formula X1-X2-O_{3-δ} where X1=Ba, Sr or mixtures thereof and X2=Ce, Zr, Y, Nd, Yb, Sm, La, Hf, Pr or mixtures thereof. The combined atomic ratio of Y, Nd, Yb, Sm and La to Ba and Sr may in an embodiment be between 0.1 and 0.3 inclusive.

In an embodiment the proton-conducting material is a compound or mixture of compounds of the type BaCe₁₋ₓXₓO_{3-δ}, where Ba is barium or strontium, Ce is cerium, X is one of yttrium and lanthanum, and x is a number in the range of 0.1≦x≦0.3. The proton-conducting material may be a compound of the formula BaCe_{1-x-y}X1ₓX2_{y}O_{3-δ}, where Ba is barium, Ce is cerium, X1 is one of yttrium and lanthanum, X2 is one of neodymium, zirconium and hafnium, x is a number in the range 0.1≦x≦0.3, and y is a number in the range 0≦y≦0.9. In an embodiment there may also be a second porous layer adjacent to and contacting the non-porous layer, the second porous layer also primarily comprising ion-conducting material, the non-porous layer being situated between the two porous layers. δ means no stoichiometric requirement on the oxygen.

Also provided is a process of manufacturing a ceramic membrane for a solid oxide fuel cell, comprising the steps of mixing a proton conducting ceramic in powder form with a pore-forming material, pressing the mixture of the proton conducting ceramic and pore forming material to form a first layer, pressing an additional quantity of the proton conducting ceramic in powder form adjacent to the first layer to form a second layer, and sintering the first and second layers.

A second porous layer may be added by pressing an additional quantity of a mixture of the proton conducting ceramic in powder form with a pore-forming material to form a sandwich of two porous layers with the non-porous layer in between the porous layers. The second porous layer may be added before sintering the first, second and third layers.

A catalyst may be added to the porous layer or layers after the step of sintering the layers. If there is only one porous layer a catalyst may also be applied to the side of the non-porous layer not adjacent to the porous layer.

The proton conducting ceramic in powder form may be produced by the steps of forming a solution in water of salts of metals or salts of metals complexed with destructable ligands, the anions of the salts being selected so that only the metal ions and oxide ions will remain after evaporation of the solution, and combustion and heat treatment of the residue left after evaporation, adding a chelating agent to the solution, adding an oxidant to the solution, adding ammonia to the solution, evaporating the water, and igniting the residue left from the evaporation of the water to form a powder.

A solid oxide fuel cell may be constructed comprising the ceramic membrane, a first electrical connector connected to a first side of the ceramic membrane, a second electrical connector connected to a second side of the ceramic membrane, a conduit arranged to convey a hydrocarbon to the first side of the ceramic membrane, a conduit arranged to convey oxidant to the second side of the ceramic membrane, a conduit arranged to convey a dehydrogenated hydrocarbon from the first side of the ceramic membrane, and a conduit arranged to convey exhaust from the second side of the ceramic membrane.

In a first exemplary embodiment, a bi-layered membrane is formed of a dense BCY thin film supported on a porous BCY substrate via co-pressing and then co-sintering precursor nanopowders. We also investigate the performance of a SOFC with BCY thin film electrolyte and Pt as the electrode catalyst impregnated into the porous BCY substrate for dehydrogenation of ethane to ethylene and co-generation of electrical energy.

In a second exemplary embodiment, we report a simple and cost-effective method for fabricating an integral proton conductive membrane of Y and Nd doped BCeO_{3-δ} (BCYN), comprising a dense thin film constructed integrally with two porous thick layers on each side. We also will show that a SOFC consisting of this proton conductive membrane impregnated with Pt into porous layers co-generates ethylene selectively and electrical energy efficiently from ethane.

An alternative and preferred catalyst is a metal embedded in a metal oxide. The metal may be for example copper, copper-nickel alloy or copper-cobalt alloy, and the oxide may be for example Cr₂O₃.

Other proton conductors than those shown in the exemplary embodiments could be used. Some examples of proton conductors that could be used are BaCe_{1-x-y}ZrₓY_{y}O₃ (0≦x≦0.9, 0.1≦y≦0.2), BaCe_{1-x-y}YₓNd_{y}O₃ 0.1≦x+y≦0.2; 0.1≦x≦0.2; 0.1≦y≦0.2, and X1-X2-X3-X4-O_{3-δ} where X1=Ba, Sr or mixtures thereof; X2=Ce; X3=Zr; X4=Y, Nd, Yb or Sm or mixtures thereof, and the atomic ratios of the elements are defined by X1=1, 0≦X2≦1, 0≦X3≦1, 0≦X4≦1, X2+X3+X4=1. δ means no stoichiometric requirement on the oxygen.

### BRIEF DESCRIPTION OF THE FIGURES

FIG. 1 shows an XRD pattern of BCY precursor powders prepared by the combustion method of the first exemplary embodiment.

FIG. 2 shows a TEM image of BCY precursor powders prepared by the combustion method of the first exemplary embodiment.

FIG. 3 shows XRD patterns of bi-layered BCY membrane surfaces on (a) the thin film side and (b) the porous substrate side.

FIG. 4 shows (a) Cross-sectional and (b) surface SEM images of the bi-layered BCY membrane of the first exemplary embodiment, (c) surface SEM image of the BCY porous substrate, and EDS patterns of the Pt impregnated porous substrate area close to the (d) thin film and (e) porous substrate surface.

FIG. 5 shows current density-voltage and power density curves of the fuel cell of the first exemplary embodiment at 650 and 700° C. The flow rates of ethane and oxygen each are 100 mL·min⁻¹.

FIG. 6 shows electrochemical impedance spectra (EIS) of the fuel cell of the first exemplary embodiment with BCY thin film electrolyte on a porous substrate and Pt electrodes. The flow rates of ethane and oxygen each are 100 mL·min⁻¹.

FIG. 7 shows conversion and ethylene selectivity changes for the first exemplary embodiment at different discharging current densities. The flow rates of ethane and oxygen each are 100 mL·min⁻¹.

FIG. 8. shows XRD patterns of (a) BCYN precursor powder prepared by the combustion method of the second exemplary embodiment, and (b) BCYN membrane comprising a dense film between porous layers sintered at 1400° C.

FIG. 9 shows a TEM image of BCYN precursor powder prepared by the combustion method.

FIG. 10 shows (a) a cross-sectional SEM image of BCYN thin film between porous layers, and (b) an EDS pattern of centre area (frame) close to the dense film between porous layers.

FIG. 11 shows Current density-voltage and power density curves of the ethane conversion fuel cell at 650° C. and 700° C. The flow rates of ethane and oxygen each are 100 mL·min⁻¹.

FIG. 12 shows a solid oxide fuel cell reactor.

### DETAILED DESCRIPTION

### First Exemplary Embodiment

BCY precursor synthesis and bi-layered membrane fabrication

BaCe_{0.85}Y_{0.15}O_{3-δ} (BCY) precursor nanopowder was prepared by a combustion method. Stoichiometric amounts of Ba(NO₃)₂, Ce(NO₃)₃.6H₂O and Y(NO₃)₃.6H₂O first were dissolved in de-ionized water. Subsequently, citric acid was added as chelating agent and NH₄NO₃ as oxidant, to form a solution with citric acid/total metal/NH₄NO₃ molar ratio 1.5:1:3. The resulting solution was adjusted to pH of 8 using ammonium hydroxide and then heated on a hot plate. Water evaporated and the residue formed brown foam which then ignited to leave crude precursor as a very fine nanopowder.

Bi-layered membrane of dense BCY thin film supported on porous BCY substrate was easily fabricated via a co-pressing method using the synthesized nanopowders. BCY precursor powder and starch (30 wt. %) were thoroughly mixed with isopropanol to form a slurry. After evaporation of isopropanol, the dry mixture of powders was first pressed at 2 t in a stainless-steel die with 2.54 cm ID to form a substrate disc. Then, a thin second layer of the BCY precursor powder was added to completely cover the substrate disc, and the combination was pressed at 5 t to form a bi-layered disc. Finally, the bi-layered disc was sintered at 1600° C. for 10 h to obtain a non-porous, dense BCY thin film supported on porous BCY substrate.

BCY Precursor and Bi-Layered Membrane Characterization

The phase structures of samples were identified using a Rigaku Rotaflex X-ray diffractometer (XRD) with Co Kα radiation. The shape and particle size of precursor powders were determined using a Philips Morgagni 268 transmission electron microscope (TEM). Microstructure and morphology of samples and Pt concentrations in the substrate were determined using a Hitachi S-2700 scanning electron microscope (SEM) with energy dispersive X-ray spectroscope (EDS).

Solid Oxide Fuel Cell Assembly and Test

Platinum was selected for use as both anode and cathode catalyst for activation of both ethane and oxygen in fuel cell. To form the anode, a concentrated solution of (NH₄)₂Pt(NO₃)₆ was impregnated into the porous substrate 10 times, dried and heated at 500° C. following each impregnation, and then the resulting Pt/BCY was obtained when (NH₄)₂Pt(NO₃)₆ decomposed and Pt metal deposited on the pore walls of BCY. To form the cathode and current collectors, Pt paste was applied to each side of the discs and calcined at 900° C. for 0.5 h to prepare the membrane electrode assemblies (MEA).

The fuel cell was set up by placing the MEA between coaxial pairs of alumina tubes and the outer tubes were sealed to the outer rim of the MEA using ceramic sealant. The diameter of alumina tubes is 2 cm, the surface area of Pt past current collectors is 0.28 cm², and the thickness of MEA is about 9 mm. The cell then was heated in a Thermolyne F79300 tubular furnace to cure the sealant, and the temperature was adjusted to the selected operating temperature. Ethane and oxygen were used as anode and cathode gases, respectively.

All electrochemical tests were performed using a Solartron 1287 electrochemical interface together with 1255B frequency response analyzer. The outlet gases from the anode chamber were analyzed at 80° C. using a Hewlett-Packard model HP5890 gas chromatograph (GC) equipped with a packed bed column (OD: ⅛ in; length: 2m; Porapak QS) and a thermal conductivity detector. The ethane conversion and ethylene selectivity were calculated according to the previously reported method [5].

Results and Discussion

Characterization of BCY Precursor Powders

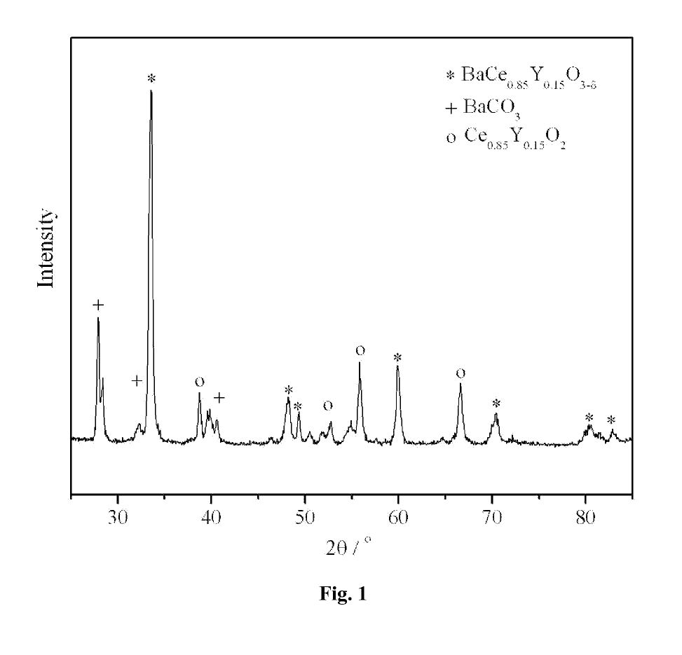

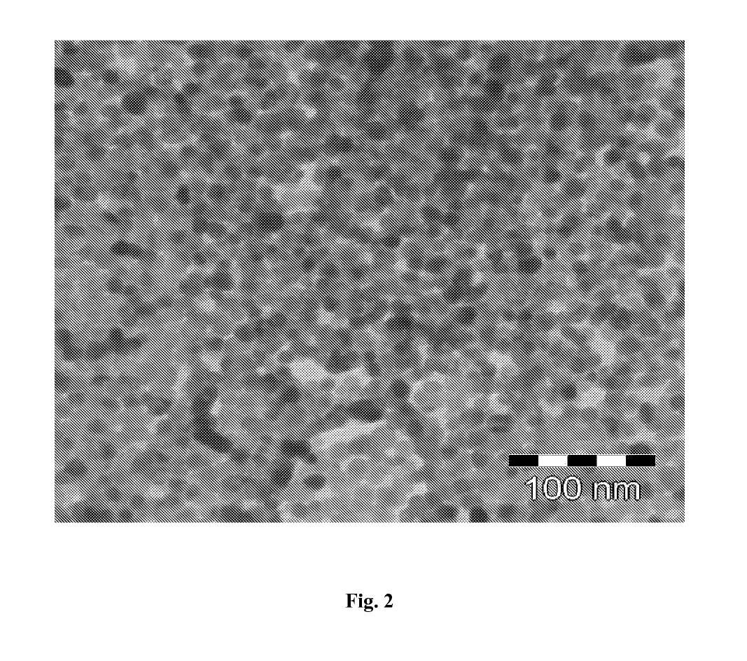

The metal ions from each of the components of the preparation solution were well distributed and chelated as citrates. Ammonium nitrate (NH₄NO₃) was added to the solution to promote ignition and oxidation. When the mixture was dried and then ignited in air it formed a very fine powder comprising nanoparticles of BCY perovskite mixed with lesser amounts of oxides or carbonates of the component metals. XRD pattern of BCY precursor powder (FIG. 1) displayed predominantly perovskite peaks of BCY with weaker peaks for small amounts of BaCO₃ and Ce₁₋ₓYₓO₂. Thus the BCY perovskite phase was readily obtained during combustion, but the perovskite formation reaction was incomplete after the ignition stage. TEM images (FIG. 2) showed that the as-combusted powders were uniformly sized particles with diameters about 20 nm. It suggested that during the combustion process, the large amount of gas evolved facilitated formation of nanometer-sized powders. The as-combusted powder was a bulky, loose material with large specific volume, 15.1 cm³·g⁻¹, about 100 times greater than that of BCY pellets sintered at 1600° C. with loose packing of the well-spaced very small particles.

Structure of BCY Bi-Layered Proton Conducting Membrane

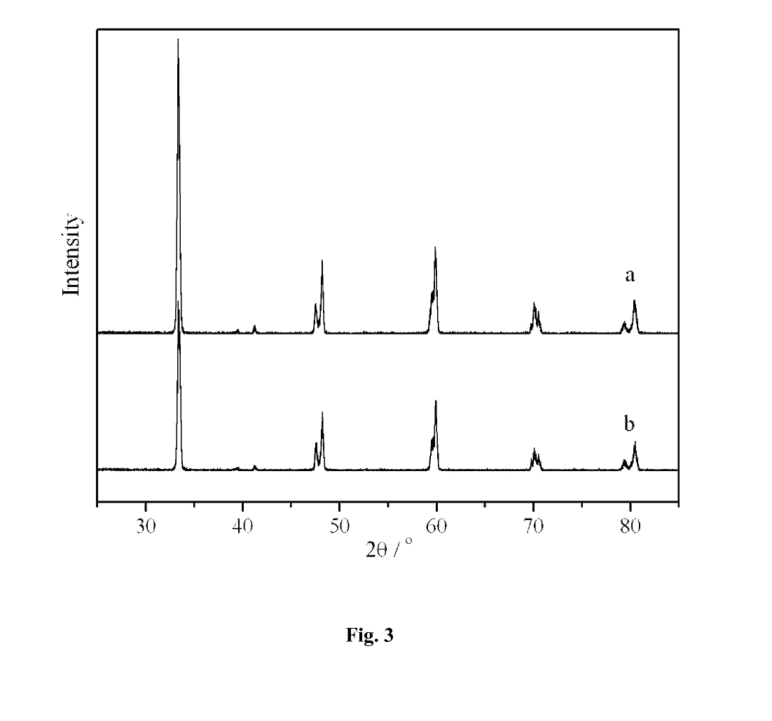

XRD patterns of both sides of co-pressed bi-layered disc showed that the thin film and the porous layer each comprised highly crystalline BCY after sintering at 1600° C. (FIG. 3). Comparing to the precursor powders, the diffraction peaks for the BCY perovskite phase became sharper and stronger for each layer, whereas the diffraction peaks for other compounds, such as BaCO₃, were no longer in evidence. It indicated that the oxide components of the precursor nanopowder reacted to form BCY perovskite phase in-situ completely, and that all pore former (starch) was destroyed by oxidation. The diffraction peaks of the thin film side were somewhat stronger than those for the porous substrate, which might be attributed to the more dense structure of BCY thin film.

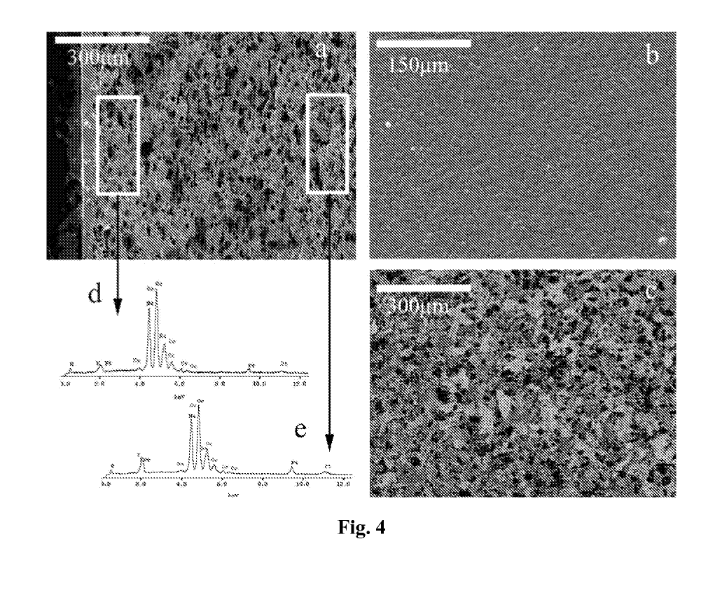

FIG. 4(a), (b) and (c) showed the SEM images of dense thin film surface, cross-sectional bi-layered membrane and the porous substrate surface, respectively. The BCY thin film was dense, uniform, had no cracks or holes, about 30 μm thick, and was strongly bonded to the thick BCY porous substrate layer. It illustrated that an integral structure comprising a bi-layered combination of the same material, a thin, dense film and a porous support, was prepared successfully using a co-pressing method, a simple and cost-effective process. The structure is similar to the bi-layered YSZ electrolyte fabricated by sequentially tape casting YSZ slurry and then a slurry of YSZ with pore former, followed by co-sintering, which exhibited excellent performance for direct oxidation of hydrocarbon fuel after impregnation of Cu-ceria anode catalyst into porous layer [17]. The extremely loose, evenly sized BCY precursor nanopowder met the strict requirements for fabrication of thin films via co-pressing: a loose fine powder with high specific volume [18]. The nanopowder of BCY precursor was easily mixed intimately with pore former (starch) and so was suitable for preparation of both a dense, thin film of BCY and a porous substrate on which it was supported.

EDS analysis results showed that Pt catalyst was impregnated throughout the porous substrate with porosity about 39% which was measured using a standard test method based on Archimedes' principle [19]. Analyses at areas close to the thin film and at the surface of the substrate (rectangular frames in the FIG. 4(a)) showed that Pt loading was about 8.1 wt. % close to the dense thin layer (FIG. 4(d)) and about 13.8 wt. % close to the surface of the porous layer (FIG. 4(e)). The penetration by the catalyst precursor solution showed that the pore structure of the BCY porous substrate was open and contiguous.

Open Circuit Voltage of Ethane Solid Oxide Fuel Cell Reactors

A fuel cell comprising Pt/BCY anode, BCY thin film electrolyte and Pt cathode was fed with 100 mL·min⁻¹ each of dry ethane and oxygen as anode and cathode feeds, respectively. Dry ethane was used in order to avoid reaction of ethane and water in high temperature then lower the ethylene selectivity. Water could be seen in the cathode gas outlet tube whilst not in the anode gas outlet tube which connecting from low position to high position during the fuel cell operating. It revealed that there was proton or hydrogen production in the anode of fuel cell and transportation through electrolyte then formation of water with oxygen in the cathode. The open circuit voltages (OCVs) of the fuel cell were 0.98 V and 0.95 V at 650° C. and 700° C., respectively. They were lower than the theoretical OCVs of 0.99 V at 650° C. and 0.98 V at 700° C. for the electrochemical dehydrogenation of ethane (eq 1), which were calculated by Nernst equation (eq 2). During the calculation, the E° (T) was obtained from ΔG° (T) (eq 3) which was calculated using HSC Chemistry Software and the partial pressures of gas species were determined from GC analysis of as composition.

$$\begin{matrix}{C}_{2} {H}_{6} ( g ) + \frac{1}{2} {O}_{2} ( g ) = {C}_{2} {H}_{4} ( g ) + {H}_{2} O ( g ) & ( 1 ) \\ E = {E}^{o} ( T ) - \frac{RT}{2 F} ln ( \frac{{P}_{{H}_{2} O} {P}_{{C}_{2} {H}_{4}}}{{P}_{{C}_{2} {H}_{6}} {P}_{{O}_{2}}^{1 / 2}} ) & ( 2 ) \\ {E}^{o} ( T ) = - \frac{Δ {G}^{o} ( T )}{2 F} & ( 3 )\end{matrix}$$

The lowness of measured OCV relative to the theoretical values especially at 700° C. might be resulted from the complicated and multiple-step reactions of ethane over Pt anode catalyst in the proton conducting SOFC reactors at high temperature and somewhat electronic conduction in the BCY proton conducting electrolyte due to the dry and reduced gas of ethane fed [20].

Electrochemical Performance of Ethane Solid Oxide Fuel Cell Reactors

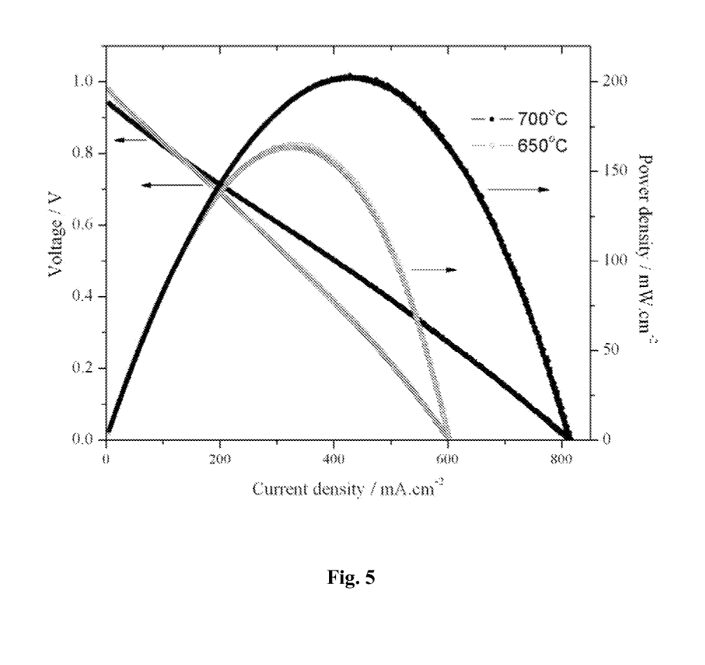

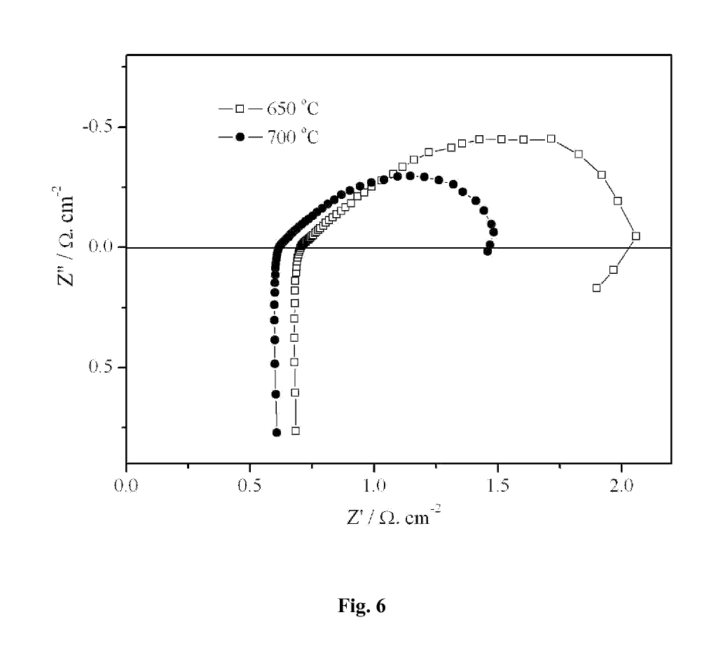

The voltage-current and power density curves of the fuel cell operated at 650° C. and 700° C. are presented in FIG. 5. At 650° C., the maximum power density of the fuel cell was 163 mW·cm⁻² at current density 338 mA·cm⁻². At 700° C., the maximum power density of the fuel cell increased to 202 mW·cm⁻² at current density 438 mA·cm⁻². The power density of the present integrally structured BCY bi-layered membrane based fuel cell was significantly better than that of the fuel cells based on thick BCY electrolyte membrane which had the maximum power density of 174 mW·cm⁻² at 700° C. [6], demonstrating that the design had the intended benefits. FIG. 6 showed the electrochemical impedance spectra (EIS) of the fuel cell under open circuit conditions. The intercepts with the real axis at high frequency and the succeeding semi-circle, assigned to electrolyte and electrode polarization resistances, respectively, were both significantly smaller than those of the fuel cell using thick BCY electrolyte supported MEA. The resistances for electrolyte and electrode were 0.61 and 0.85Ω·cm², respectively, compared to 2.8 and 4.2Ω·cm² for the fuel cell with 0.44 mm BCY electrolyte [6]. It was noted that the ohmic resistance was larger than one would expect for a 30 micron electrolyte, which should be original from both of dense thin film electrolyte and porous proton conducting substrate which might be without enough Pt as current collector reaching to the dense thin film electrolyte. The electrochemical performance improvement might be attributable to two factors: reduced ohmic resistance of the integrally formed thin film BCY, and enhanced TPB of the porous substrate anode impregnated with Pt [21].

Dehydrogenation of Ethane to Ethylene in Solid Oxide Fuel Cell Reactors

Pt is an excellent catalyst for ethane dehydrogenation at high temperature [4]. In the proton conducting SOFC reactor, ethane was dehydrogenated to ethylene with good selectivity with co-generation of electricity. At 650° C. ethylene selectivity was 93.1% at 23.6% ethane conversion at open circuit condition of the fuel cell reactor. The other products at the anode were hydrogen, methane, and trace amounts of carbon oxides. Hydrogen was produced from the chemical dehydrogenation of ethane over Pt catalyst supported on the porous BCY proton conducting substrate which could transport hydrogen atom from anode to cathode and consume to form water. Methane was from the thermal cracking reaction of ethane. The trace of carbon oxides might be attributed to the oxidation of ethane by oxygen ion or oxygen gas [22]: (1) BCY has low oxygen ion transport number above 650° C. thereby oxygen ion can transport from cathode to anode though BCY electrolyte; (2) it is possible that air diffuses to the anode chamber through the fuel cell sealant. At 700° C. ethane conversion was enhanced to 36.7%, ethylene selectivity slightly decreased to 90.5%, while the methane selectivity increased to 7.6%. The increase in methane formation with temperature was attributable to increased thermal cracking of C₂H₆ to form CH₄.

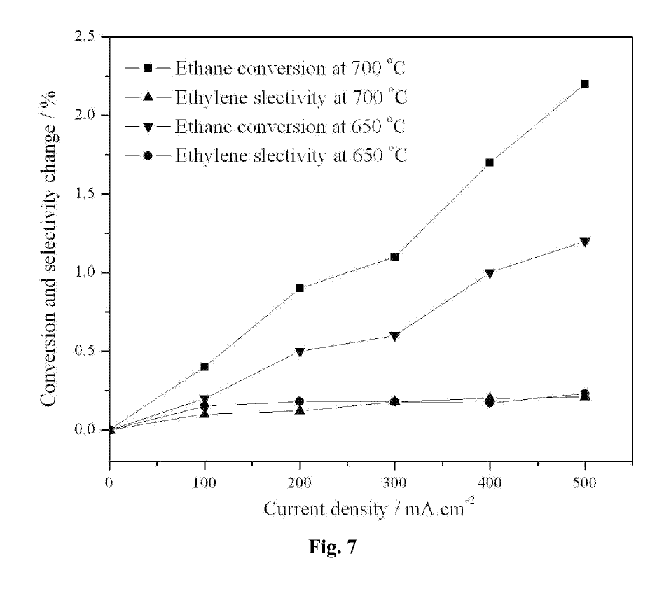

FIG. 7 illustrated the effect of discharging current density on the ethane conversion and ethylene in the fuel cells. Comparing to the open circuit condition (zero discharging current density), the conversion of ethane increased with the discharging current density since the removal of hydrogen atoms through the electrolyte was enhanced. The same current density had higher ethane conversion increment at 700° C. than 650° C. which also revealed that the electrochemical dehydrogenation enhanced relative to chemical dehydrogenation at higher temperature. The ethylene selectivity was also somewhat increased because the crack reaction of ethane to methane was probably inhibited when the current density increased.

Ethylene selectivity was higher and the process was simpler for conversion of ethane in the proton conducting SOFC comparing to conventional chemical process [4, 22]. Importantly, there were no detectable amounts of acetylene in the anode effluent under the present test conditions, which is significant for production of ethylene for use in polymerization processes since acetylene poisons several classes of polymerization catalyst [23]. Thus generation of ethylene from ethane via SOFC using a proton conducting electrolyte, in which there is no contact between any oxidant and the fuel, has advantages over alternative methods for manufacture of ethylene.

Conclusions

BaCe_{0.85}Y_{0.15}O_{3-δ} (BCY) precursor powders synthesized using a citric acid-nitrate combustion method are fairly uniformly sized particles about 20 nm in diameter, with high specific volume of 15.1 cm³·g⁻¹.

BCY thin film protonic electrolyte integrally formed and supported on thick porous BCY substrate was facilely fabricated by a method comprising co-pressing of two layers, one comprising only electrolyte precursor and the other its mixture with a pore former, followed by co-sintering at 1600° C.

Pt/BCY anodes for dehydrogenation of ethane prepared by impregnation of (NH₄)₂Pt(NO₃)₆ solution into the porous BCY layer followed by thermal decomposition at 500° C. The protonic fuel cell with BCY thin film electrolyte on Pt/BCY porous anode had excellent electrochemical performance with high selectivity to ethylene. At 650° C., the ethylene selectivity was 93.1% at 25.3% ethane conversion at maximum power density of 163 mW·cm⁻². At 700° C., ethylene selectivity was 90.5% with 36.7% ethane conversion at maximum power density of 216 mW·cm⁻². The discharging current improved the ethane conversion and ethylene selectivity.

### Second Exemplary Embodiment

BaCe_{0.85}Y_{0.1}Nd_{0.05}O_{3-δ} precursors were prepared using a combustion method. Stoichiometric amounts of Ba(NO₃)₂, Ce(NO₃)₃.6H₂O, Y(NO₃)₃.6H₂O and Nd(NO₃)₃.6H₂O were first dissolved into de-ionized water. Subsequently, citric acid was added as chelating agent and NH₄NO₃ as oxidant to form a solution in which the citric acid/total metal/NH₄NO₃ molar ratio was 1.5:1:3. Finally, the resulting solution was adjusted to pH 8 by addition of NH₄OH. The resulting mixture was heated on a hot plate until it formed a foam and then ignited to form BCYN precursor as powder.

The tri-layered proton conducting membrane comprising a dense thin film of BCYN situated between two porous BCYN layers was readily fabricated by layering, co-pressing and sintering three layers of material. First, BCYN precursor powder and starch (30%) were intimately mixed and pressed at 2 ton into a disc using a stainless-steel die with ID 2.54 cm. Then the BCYN precursor powder alone was added to form a layer fully covering the substrate, and was pressed at 2 ton to form a bi-layered disc. Thirdly, another layer of the mixture of starch and BCYN precursor powder was layered fully over the second layer and the combination was pressed at 5 ton to form a tri-layered disc. Finally, the pressed tri-layered disc was sintered at 1400° C. for 10 h.

The Pt/BCYN composite anode and cathode electrodes were prepared by impregnating (NH₄)₂Pt(NO₃)₆ solution into the BCYN porous layers, drying, and repeating the process several times, followed by heating at 500° C. to deposit Pt on the pores' walls. Pt paste was applied onto each side of the sintered discs, to form current collectors, and then the discs were calcined at 900° C. for 30 min to form MEA.

The phase structures of materials were identified using a Rigaku Rotaflex X-ray diffractometer (XRD) with Co Kα radiation. The shape and particle size of BCYN precursor powders were determined using a Philips Morgagni 268 transmission electron microscope (TEM). The morphology and metal concentration of BCYN membrane were determined using a Hitachi S-2700 scanning electron microscope (SEM) with energy dispersive X-ray spectroscope (EDS).

The fuel cell was set up by placing the MEA between concentric pairs of alumina tubes and sealed in a tubular furnace. All electrochemical tests were conducted using a Solartron 1287 electrochemical interface together with 1255B frequency response analysis instrumentation. The outlet gases from the anode chamber were analyzed using a Hewlett-Packard model HP5890 GC. Ethane conversion and ethylene selectivity were calculated according to the reported method [5].

Results and Discussion

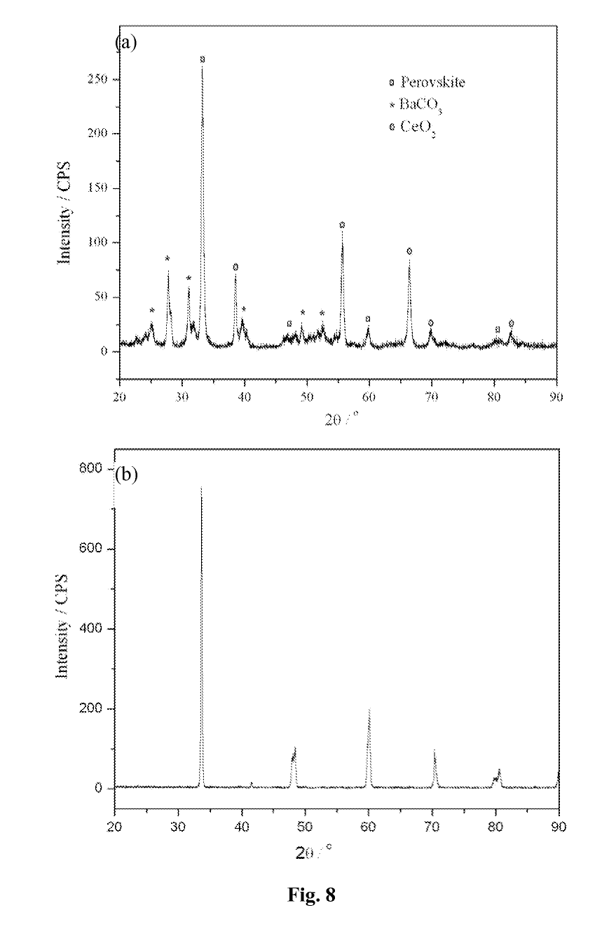

Very fine and loose precursor powders were obtained using the combustion method. The XRD pattern (FIG. 8 (a)) showed that the powders comprised primarily BCYN perovskite oxide, with lesser amounts of BaCO₃ and CeO₂. This result showed that the metal ions chelated with citric acid were fully dispersed throughout the initial solution, and the high dispersion of the metal ions led to very rapid, but incomplete, formation of BCYN perovskite during combustion. The presence of BaCO₃ was attributed to the reaction of a portion of the Ba²⁺ with CO₂ formed during combustion of the metal citrates and, consequently, a small amount of CeO₂ also was formed during gel combustion.

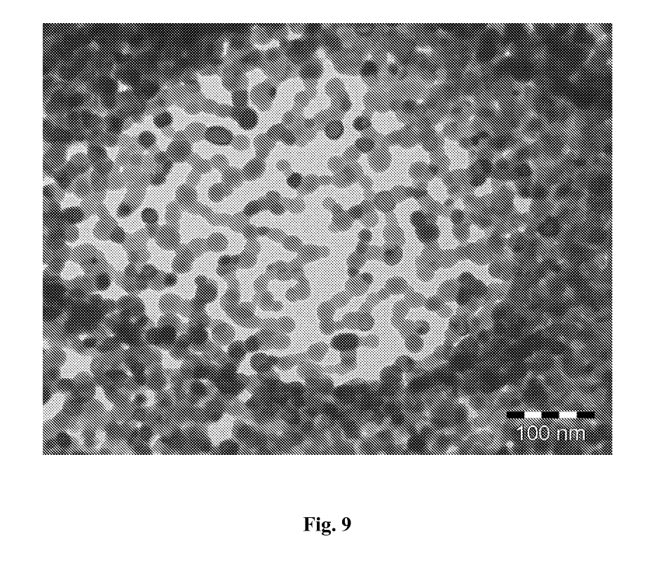

The precursor powders were substantially spherical particles averaging about 25 nm (TEM; FIG. 9). The nanoparticles were well separated because NH₄NO₃ decomposition during the metal citrate complex gel combustion caused evolution of a large amount of gas. The resulting loose specific volume of the nanopowders was 14.6 cm³·g⁻¹, about 100 times greater than that of BCYN pellets sintered at 1400° C. Co-pressing is a very simple and cost-effective process for preparing thin films of ceramic materials, which requires loose, very fine powders [18]. Thus the loose nanopowders made it facile to fabricate BCYN dense thin film between porous layers using the co-pressing method followed sintering at high temperature.

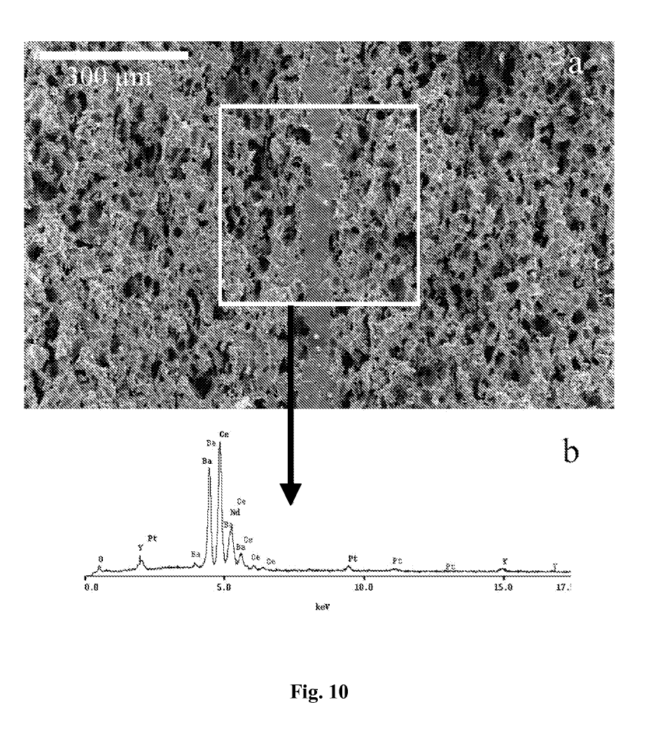

The XRD pattern (FIG. 8(b)) showed that the co-pressed tri-layered disc after sintering at 1400° C. comprised only BCYN perovskite phase and that no other materials such as BaCO₃ were present, in contrast to the raw material. Thus the precursor nanopowders formed pure BCYN pervoskite oxide in situ, and the starch pore former had burned off. Cross-sectional SEM images (FIG. 10 (a)) showed that the BCYN membrane comprised three layers. The central layer was a dense thin film ca. 50 μm thick, free of cracks and well-bonded to the porous layers with no delamination. Each layer of the tri-layered proton conductive membrane was only BCYN, and the structure was integrally formed when sintered. Therefore, the symmetrical MEA components each had the same properties such as expansion coefficient, leading to good mechanical and thermal stability of SOFC when compared to conventional single composite electrode-supported thin film electrolyte MEA [31].

After (NH₄)₂Pt(NO₃)₆ impregnation and heat treatment, the concentration of Pt was high (7.7%) in BCYN pores close to the central dense thin film (FIG. 10(b)). Thus the pores in the porous layers were open and contiguous to allow either impregnation solution or fuel cell feeds to reach the region adjacent the electrolyte interface. Clearly, the porous layers can be impregnated with alternative catalyst precursors to form a variety of porous composite electrodes with high TPB as well as complex electrode microstructures at low temperature [30, 32].

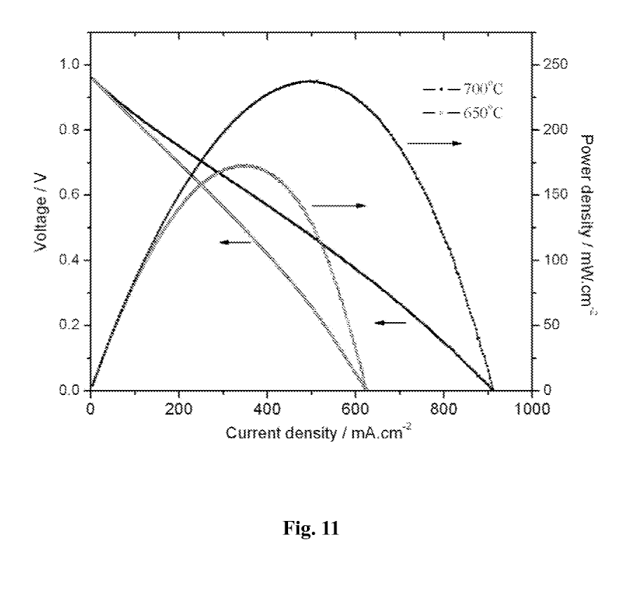

Exemplary fuel cells were constructed comprising Pt/BCYN-BCYN-Pt/BCYN tri-layered membranes with Pt current collectors. The anode and cathode feeds were ethane and oxygen, respectively, each 100 mL·min⁻¹. At elevated temperatures ethane was dehydrogenated catalytically to ethylene at the anode, with cogeneration of electricity. Protons were conducted through the BCYN electrolyte to the cathode where they were consumed by oxygen to form steam. At 650° C., ethylene selectivity was 91.9% at 24.3% ethane conversion. The major by-product was methane, and there were trace amounts of carbon oxides but no acetylene. At 700° C., ethane conversion increased to 37.9% while ethylene selectivity decreased slightly to 89.3% and selectivity to methane increased. The maximum power density was 173 mW·cm⁻² at current density 355 mA·cm⁻² when operated at 650° C. (FIG. 11). When the operating temperature was 700° C., the maximum power density of the fuel cell increased to 237 mW·cm⁻² at current density 502 mA·cm⁻².

Conclusions

About 25 nm spherical precursor powders of BCYN were synthesized by a combustion method. Integral tri-layered BCYN proton conducting membranes were readily fabricated using cost-effective and simple methods of co-pressing and co-sintering. The exemplary membrane comprised a central ca. 50 μm dense film of electrolyte integrally formed between porous thick layers. Pt as catalyst was easily impregnated into the BCYN porous layers to form symmetrical composite anode and cathode. The SOFC so made was used to convert ethane to value-added ethylene at high selectivity with co-generation of electricity at high power density.

### FURTHER EXAMPLES

### Example 1

BaCe_{0.7}Zr_{0.1}Y_{0.15}Yb_{0.05}O_{3-δ} proton conductor powders were prepared by solid state reactions. Starting materials BaCO₃, CeO₂, ZrO₂, Y₂O₃, and Nd₂O₃ were ball-milled in stoichiometric ratio for 24 h. The pressed mixtures then were calcined at 1300° C. for 10 h. Then the resulted materials were ball-milled again for 24 h, pressed in a stainless steel mold to form discs, and sintered at 1500° C. for 10 h with heating and cooling rates of 1° C.·min⁻¹. Then platinum paste was screen printed onto each side of polished pellets, calcined at 900° C. for 30 min to obtain membrane electrode assemblies (MEA).

The SOFC reactor was fabricated by placing the MEA between concentric pairs of alumina tubes in a vertical Thermolyne F79300 tubular furnace. After the SOFC reached the prescribed operating temperature, ethane (150 mL·min⁻¹) and oxygen (150 mL·min⁻¹) were supplied as anode and cathode feed gas, respectively. All the electrochemical tests were performed using a Solartron 1287 electrochemical interface together with 1255B frequency response analysis instrumentation. The outlet gas from the anode chamber was analyzed using a Hewlett-Packard model HP5890 GC having a thermal conductivity detector. At the operating temperature of 700° C. the maximum power density of the fuel cell reactor was 106 mW·cm⁻² and the ethylene yield was 18% with 90% selectivity.

### Example 2

BaZr_{0.1}Ce_{0.7}Y_{0.15}Pr_{0.05}O_{3-δ} (BZCYP) precursor powders were prepared by a modified combustion method. Stoichiometric amounts of Ba(NO₃)₂, ZrO(NO₃)₂.xH₂O, Ce(NO₃)₃.6H₂O, Y(NO₃)₃.6H₂O an Pr(NO₃)₃.6H₂O first were dissolved in water. Subsequently, citric acid was added as chelating agent and NH₄NO₃ as oxidant. The molar ratio of citric acid:total metal:NH₄NO₃ is 1.5:1:3. The pH of resulting solution was adjusted using ammonium hydroxide and then heated on a hot plate. Water evaporated and the residue formed foam which then ignited to form fine powder. Then the powders were calcined at 900° C. for 10 h in air. Then the powders were ball-milled again for 24 h, pressed in a stainless steel mold to form discs, and sintered at 1500° C. for 10 h with heating and cooling rates of 1° C.·min⁻¹. Then platinum paste was screen printed onto each side of polished pellets, calcined at 900° C. for 30 min to obtain membrane electrode assemblies (MEA).

The SOFC reactor was fabricated by placing the MEA between concentric pairs of alumina tubes in a vertical Thermolyne F79300 tubular furnace. After the SOFC reached the prescribed operating temperature, ethane (150 mL·min⁻¹) and oxygen (150 mL·min⁻¹) were supplied as anode and cathode feed gas, respectively. All the electrochemical tests were performed using a Solartron 1287 electrochemical interface together with 1255B frequency response analysis instrumentation. The outlet gas from the anode chamber was analyzed using a Hewlett-Packard model HP5890 GC having a thermal conductivity detector. At the operating temperature of 650° C. the maximum power density of the fuel cell reactor was 77 mW·cm⁻² and the ethylene yield was 8% with 95% selectivity.

### Example 3

BaZr_{0.1}Ce_{0.7}Y_{0.2}O_{3-δ} (BZCY) precursor powders were prepared by a modified combustion method. Stoichiometric amounts of Ba(NO₃)₂, ZrO(NO₃)₂.xH₂O, Ce(NO₃)₃.6H₂O and Y(NO₃)₃.6H₂O first were dissolved in water. Subsequently, citric acid was added as chelating agent and NH₄NO₃ as oxidant. The molar ratio of citric acid:total metal:NH₄NO₃ is 1.5:1:3. The pH of resulting solution was adjusted using ammonium hydroxide and then heated on a hot plate. Water evaporated and the residue formed foam which then ignited to form fine powder. Then the powders were calcined at 900° C. for 10 h in air. BaZr_{0.1}Ce_{0.7}Y_{0.1}Yb_{0.1}O_{3-δ} (BZCYYb) precursor powders were prepared similar to BZCY precursor powders.

Bi-layered membrane of dense BZCY thin film supported on porous BZCYYb substrate was fabricated via a co-pressing method using the synthesized precursor powders. BZCYYb precursor powder and starch were thoroughly mixed and were first pressed in a stainless-steel die to form a substrate disc. Then, a thin second layer of the BZCY precursor powder was added to completely cover the substrate disc, and the combination was pressed again to form a bi-layered disc. Finally, the bi-layered disc was sintered at 1600° C. for 10 h to obtain a non-porous, dense BZCY thin film supported on porous BZCYYb substrate.

Pt was impregnated into porous BZCYYb substrate as cathode catalyst. CuCrO₂ powder catalyst precursor and gold paste, to form the current collector, was sequentially screen printed onto the BZCY film surface as anode (0.5 cm²) to complete the membrane electrode assemblies (MEA).

The SOFC reactor was fabricated by placing the MEA between concentric pairs of alumina tubes in a vertical Thermolyne F79300 tubular furnace. After the SOFC reached the prescribed operating temperature, ethane (150 mL·min⁻¹) and oxygen (150 mL·min⁻¹) were supplied as anode and cathode feed gas, respectively. The power density of the fuel cell reactor increases from 162 mW·cm⁻² to 318 mW·cm⁻² and the ethylene yield increases from about 9% to 38% as the operating temperature rises from 650° C. to 750° C.

### Example 4

BaZr_{0.1}Ce_{0.7}Y_{0.2}O_{3-δ} (BZCY) precursor powders were prepared similar to BZCP powders in EXAMPLE 3. A bi-layered proton conducting membrane of dense film supported on porous substrate was fabricated via a co-pressing method using the synthesized BCYZ precursor nanopowder. 80 wt % BCYZ precursor powder and 20 wt % starch were thoroughly mixed with isopropanol to form a slurry. After evaporation of isopropanol, the dry mixture of powders was first pressed to form a substrate disc. Then, a thin second layer of the BCYZ precursor powder was added to completely cover the substrate disc, and the combination was pressed at 5 t to form a bi-layered disc. Finally, the bi-layered disc was sintered at 1500° C. for 10 h to obtain a dense BCYZ thin film supported on porous BCYZ substrate.

A solution prepared by dissolving Cu(NO₃)₂ and Cr(NO₃)₃.6H₂O in water was sequentially impregnated into the porous BCYZ substrate, dried and heat, and the process was repeated several times. During the heating treatment, both Cu(NO₃)₂ and Cr(NO₃)₃ decomposed to form oxides deposited within the porous BCYZ proton conducting matrix. During heating the reactor to operating temperature 5% H₂ was fed into the anode, and Cu—Cr-oxide was reduce to form Cu—Cr₂O₃/BCYZ composite anode with high TPB. Pt paste was applied to the opposite dense thin film surface to form the cathode and thus complete the membrane electrode assemblies (MEA).

The SOFC reactor was fabricated by placing the MEA between concentric pairs of alumina tubes in a vertical Thermolyne F79300 tubular furnace. After the SOFC reached the prescribed operating temperature, ethane (150 mL·min⁻¹) and oxygen (150 mL·min⁻¹) were supplied as anode and cathode feed gas, respectively. The ethylene yield of the anode supported SOFC reactor at different operating different temperatures increased with temperature from 650° C. to 750° C., the ethane conversion increased from 9.1% to 45.8%, while the ethylene selectivity decreased from 98.3% to 88.7%. The maximum power density increased from 163 mW·cm⁻² to 351 mW·cm⁻² when the operating temperature increased from 650° C. to 750° C.

### Example 5

BaZr_{0.1}Ce_{0.7}Y_{0.15}Nd_{0.05}O_{3-δ} (BZCYN) precursor powders were prepared similar to BZCP powders in EXAMPLE 3. The tri-layered proton conducting membrane comprising a dense thin film of BZCYN situated between two porous BZCYN layers was readily fabricated by layering, co-pressing and sintering three layers of material. First, BZCYN precursor powder and starch (20%) were intimately mixed and pressed at 2 ton into a disc using a stainless-steel die with ID 2.54 cm. Then the BZCYN precursor powder alone was added to form a layer fully covering the substrate, and was pressed at 2 ton to form a bi-layered disc. Thirdly, another layer of the mixture of starch and BZCYN precursor powder was layered fully over the second layer and the combination was pressed at 5 ton to form a tri-layered disc. Finally, the pressed tri-layered disc was sintered at 1500° C. for 10 h.

The Pt/BZCYN composite anode and cathode electrodes were prepared by impregnating (NH₄)₂Pt(NO₃)₆ solution into the BZCYN porous layers, drying, and repeating the process several times, followed by heating at 500° C. to deposit Pt on the pores' walls. Pt paste was applied onto each side of the sintered discs, and then the discs were calcined at 900° C. for 30 min to form MEA

The SOFC reactor was fabricated by placing the MEA between concentric pairs of alumina tubes in a vertical Thermolyne F79300 tubular furnace. After the SOFC reached the prescribed operating temperature, ethane (150 mL·min⁻¹) and oxygen (150 mL·min⁻¹) were supplied as anode and cathode feed gas, respectively. At 700° C., the ethane conversion is 21%, the ethylene selectivity is 93%. The maximum power density is 227 mW·cm⁻².

### Example 6

BaZr_{0.1}Ce_{0.7}Y_{0.2}O_{3-δ} (BZCY) precursor powders were prepared similar to BZCP powders in EXAMPLE 3. A bi-layered proton conducting membrane of dense film supported on porous substrate was fabricated via a co-pressing method using the synthesized BCYZ precursor nanopowder. 80 wt % BCYZ precursor powder and 20 wt % starch were thoroughly mixed with isopropanol to form a slurry. After evaporation of isopropanol, the dry mixture of powders was first pressed to form a substrate disc. Then, a thin second layer of the BCYZ precursor powder was added to completely cover the substrate disc, and the combination was pressed at 5 t to form a bi-layered disc. Finally, the bi-layered disc was sintered at 1500° C. for 10 h to obtain a dense BCYZ thin film supported on porous BCYZ substrate.

A solution prepared by dissolving Cr(NO₃)₃.6H₂O in water was sequentially impregnated into the porous BCYZ substrate, dried and heat, and the process was repeated several times. During the heating treatment, Cr(NO₃)₃ decomposed to form oxide deposited within the porous BCYZ proton conducting matrix. Pt paste was applied to the opposite dense thin film surface to form the cathode and thus complete the membrane electrode assemblies (MEA).

The SOFC reactor was fabricated by placing the MEA between concentric pairs of alumina tubes in a vertical Thermolyne F79300 tubular furnace. After the SOFC reached the prescribed operating temperature, ethane (150 mL·min⁻¹) and oxygen (150 mL·min⁻¹) were supplied as anode and cathode feed gas, respectively. The maximum power density of the fuel cell reactor was 16 mW·cm⁻² and the ethane conversion was 22% with 95% selectivity at 700° C.

### Other Embodiments

In the exemplary embodiments, a proton conducting ceramic was formed by the following steps. Nitrates of the metals comprising the ceramic were dissolved in water. Other compounds than nitrates could be used, so long as they are soluble, and the only components remaining after combustion and heat treatment are the metal ions and oxide ions. For example, one could use salts of carboxylic acids such as for example acetates, Ba(CH₃CO₂)₂.H₂O, Ce(CH₃CO₂)₃.5H₂O and Nd(CH₃CO₂)₃.xH₂O or Nd(CH₃CO₂)₃.5H₂O (different levels of hydrate); or salts of metals complexed with destructable ligands, such as (NH₄)₂Ce(NO₃)₆. An oxidant and chelating agent were also added dissolved in the water. In the exemplary embodiments, citric acid was used as the chelating agent but other chelating agents could be used to replace citric acid such as ethylene diamine tetraacetic acid (EDTA), ethylene glycol, diethanolamine, etc. Citric acid is useful and established as an appropriate chelating agent. In the exemplary embodiments, NH₄NO₃ was used as the oxidant. There is no known better alternative material to NH4NO3. This agent is known to work, is cheap and readily available, and it is destroyed in the combustion process. There are other oxidizing anions such as perchlorate (to replace nitrate), but they may have problems. For example, dry perchlorate salts may explode when shocked or heated. There are alternative cations (for ammonium), such as substituted ammonium ions and phosphonium ions, but these are all more expensive and provide no advantages. A suitable range for the chelating agent/total metal/NH₄NO₃ molar ratio is (1.2-2):1:(2-5). The pH of the solution can be adjusted to be weakly basic by the addition of ammonia. The excess ammonia is readily volatilized away. There is no known better option than ammonia for this purpose. The pH is not highly limited, but it should be weakly basic, for example a pH of 7.5-10.

The combination of the chelating agent, oxidant and base lead to formation of foam as the solution is heated and the water evaporated, as CO2 and other gases are formed. The formation of foam is helps the formation of the very small (“nano”) particles of the crude product (“precursor” below), which in turn enable rapid formation of the refined product at relatively low temperatures (compared to the solid state reaction method). In this way, a product is formed that is of high purity (one phase), high crystallinity, and very small particle size.

The solution was heated at 80-90° C. on a hot plate for 10-24 h to form foam, then the temperature was increased to 200-300° C. for 0.5-2 h to ignite the foam and obtain a precursor (mainly the same as the final material but with small amounts of impurities) as powder. At the prevailing temperature, in air, in the presence of a combustible component and an aid to oxidation, combustion results as the temperature rises. Ignition purifies the material so that the crude product is almost entirely metal ions and oxide ions, with small amounts of hydroxide, carbonate, etc. possibly present. These are removed as the crude material is heat treated, and the remaining metal ions and oxide so formed are converted to the target product as a single phase, nano-sized crystalline material.

In the exemplary embodiments, a bi-layered or tri-layered proton conducting membrane comprising a dense thin film of proton-conducting material and on or two porous layers of the material was readily fabricated by layering, co-pressing and sintering the layers of material. The porous layer or layers were formed by intimately mixing and pressing the precursor powder and a pore former. In the exemplary embodiments starch was used as the pore former at 30% by weight, but other pore formers could be used such as carbon, and other concentrations of pore former, for example 10-30% by weight. The range (of mixtures) to be used is determined by the desired porosity. Too much starch (or other pore former) will give a layer so porous that it is too fragile. Too little pore former will give a layer that is too dense, i.e. insufficiently porous to allow the gases readily to access and leave the active areas.

Intimately mixed means, in essence, that the components of the mixture are so well interdistributed that there are no “islands” of any one material, which would lead to a much wider range of pore sizes and, quite possibly, some non-porous areas. The mixing of the powder and pore former can be done for example by ball-milling them together for 1-24 h. In the exemplary embodiment with three layers, the third layer uses the same mixture of pore former and proton conductor precursor as the first one. Obviously, it is also possible to make the first and third layers with different porosity if desired.

In the exemplary embodiments the non-porous layer was formed from precursor powder alone without additives. However, as described below for the catalytic electrode layers, there may be improvements available through inclusion of small amounts of a “hardener” to increase the strength of the film.

In the exemplary embodiments the anode and cathode electrodes were prepared by impregnating (NH₄)₂Pt(NO₃)₆ solution into the porous layer or layers, drying, and repeating the process several times, followed by heating at 500° C. to deposit Pt on the pores walls. Pt paste was applied onto each side of the sintered discs, to form current collectors, and then the discs were calcined at 900° C. for 30 min to form MEA. Chemical vapour deposition and possibly other methods also can be used to deposit some catalysts, as are well known to those experienced in the field. PtCu etc. also may be useful anode catalysts. The Pt catalyst is described as an exemplary case. Ag etc. can be used as cathode catalysts. We provide an example only.

A preferred anode catalyst is mixture of a metal with a metal oxide, preferably a mixture of copper or copper-nickel alloy or copper-cobalt alloy with Cr₂O₃. For example, mixed oxides can be prepared by dissolving into water soluble salts of the different metals, chelating the metal ions with a chelating agent, neutralizing the solution, removing water by evaporation to form a gel which then is dried, and finally heating the dried gel to form a mixed oxide of the different metals. The chelating agent can be citrate ions, and ammonia can be added to the solution until the pH of the solution is about 8. The mixed oxide so formed then is reduced, for example by hydrogen, to form a composite comprising the metal (Cu, Cu—Co, Cu—Ni) and metal oxide, here Cr₂O₃. Typically, the composite oxides so formed comprise approximately spherical nanoparticles, and the reduced composites are nanoparticles comprising very small particles of the metal within a network of the oxide, Cr₂O₃.

Other “ingredients” may also be included to address specific needs. Three examples of materials that are commonly used in catalysts and/or supports are described as follows. The activities of some catalysts are enhanced in the presence of amounts, sometimes quite small, of promoters. For example, a low amount of an alkali metal may be added to hydrocarbon conversion catalysts, which obviously may apply here. Selectivity can sometimes be enhanced by addition of an amount of a component to suppress a side reaction. There may be benefit in addition of a small amount of an additional ingredient that confers on the film formed by heating crude electrolyte more hardness, i.e. less friability or tendency to cracking. One agent so used is B₂O₃, in amounts typically only 0.5-2%.

In addition to the exemplary embodiments, testing was also done on a ceramic membrane using a compound of barium, cerium, zirconium and yttrium with the following results:

| | Power density | Ethane conversion | Ethylene selectivity |
|---|---|---|---|
| 650° C. | 119 mW · cm⁻² | 21% | 96% |

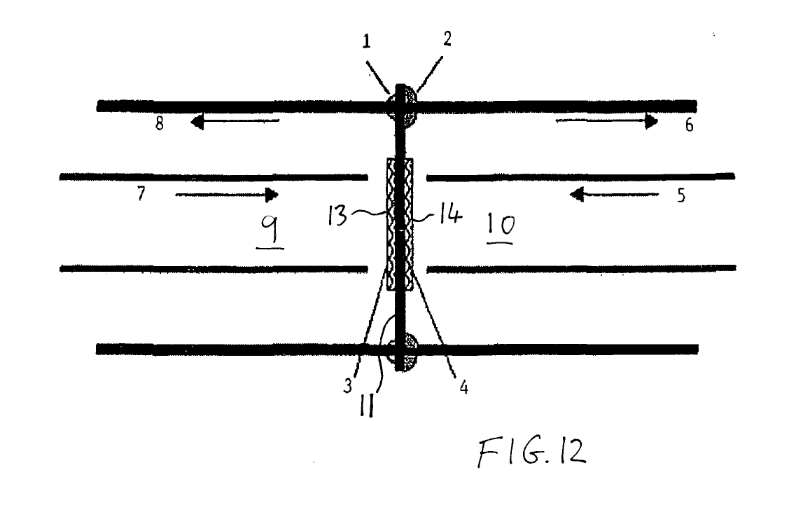

Referring to FIG. 12, there is shown a ceramic membrane 11 the opposed surfaces 13, 14 of which will act as part of the anode chamber 9 or cathode chamber 10 of a fuel cell 100. The membrane surfaces may be ground to remove segregated surface oxides and to reduce the thickness to the appropriate size. The thickness of membrane 11 should be minimized to optimize performance of fuel cell 100, but should be sufficiently thick so as to be strong enough to sustain physical integrity.

An electrode 3, 4 is applied to each of opposed faces 13, 14 of ceramic membrane 11 which will be used in fuel cell 100. Generally cathode 4 includes a catalyst selected from oxygen activation catalysts and anode 3 includes catalysts selected from the group consisting of hydrocarbon activation catalysts. The electrode for both anode 3 and cathode 4 may be a precious metal such as Pt or Pd, such as for example Pt paste. Platinum paste is commercially available for example from Hereaus Inc., CL-5100. The anode catalyst may be for example platinum, mixtures of copper and copper chromite, mixtures of iron, platinum and chromia, or a mixture of copper or copper-cobalt alloy or copper-nickel alloy with chromia. Current collectors are attached to the anode 3 and cathode 4 to obtain power from the cell. The membrane 11 may have the structure of either of the bi-layer membrane or tri-layer membrane described in this patent document.

As shown in FIG. 12, fuel cell 100 comprises an anode chamber or compartment 9 and a cathode chamber or compartment 10 having there between ceramic membrane 11 coated at opposed faces 13, 14 with the appropriate anode electrode catalyst 3 and cathode electrode catalyst 4 respectively. Anode chamber 9 and cathode chamber 10 are hermetically sealed using a high temperature ceramic sealant 1, 2 about ceramic membrane 11. A number of sealants are known but ceramic sealers such as AREMCO® 503 and most preferably glass sealants such as AREMCO® 617 may be used to hermetically seal fuel cell compartments 9 and 10.

Arrows 5, 6, 7 and 8 show the flow paths of material to and from the fuel cell. An oxidizer enters the cell as shown by arrow 5 and is exhausted along path 6 after being combined with hydrogen at the fuel cell. A material to be dehydrogenated enters the cell along path 7 and the dehydrogenated material exits the cell along path 8.

Other proton conductors than those shown in the exemplary embodiments could be used. Some examples of proton conductors that could be used are BaCe_{1-x-y}ZrₓY_{y}O₃ (0≦x≦0.9, 0.1≦y≦0.2), BaCe_{1-x-y}YₓNd_{y}O₃ 0.1≦x+y≦0.3; 0.1≦x≦0.2; 0.1≦y≦0.2, X1-X2-X3-X4-O_{3-δ} where X1=Ba, Sr or mixtures thereof; X2=Ce; X3=Zr; X4=Y, Nd, Yb or Sm or mixtures thereof, and the atomic ratios of the elements are defined by X1=1, 0≦X2≦1, 0≦X3≦1, 0≦X4≦1, X2+X3+X4=1. δ means no stoichiometric requirement on the oxygen. More generally, the proton-conducting material can be a compound of the formula X1-X2-O_{3-δ} where X1=Ba, Sr or mixtures thereof and X2=Ce, Zr, Y, Nd, Yb, Sm, La, Hf, Pr or mixtures thereof. The combined atomic ratio of Y, Nd, Yb, Sm and La to Ba and Sr may in an embodiment be between 0.1 and 0.3 inclusive. The proton conductors disclosed here other than for which results are shown are believed to be useful due to the elements having similar properties to the properties of the exemplary embodiments. In a preferred embodiment, the proton conducting material forms a perovskite. In a more preferred embodiment, the proton conductor forms a perovskite with a unit cell with dimensions not changed by more than 5% relative to the BCYN embodiment described above. In a still more preferred embodiment, the proton conductor forms a perovskite with a unit cell with dimensions not changed by more than 4% relative to the BCYN embodiment described above and in a still further more preferred embodiment, the proton conductor forms a perovskite with a unit cell with dimensions not changed by more than 2% relative to the BCYN embodiment described above. Preferably, the unit cell of the perovskite is not distorted (e.g. leaning or twisting of an axis). An interface between materials with different properties can impede flow between the materials and for this reason the porous layer or layers should be similar to the non-porous layer in order to reduce the resistance of the flow of protons between the layers. Thus, preferably there is a contiguous extent of the same or similar material throughout the dense (impermeable to gases and liquids) and porous layers (gas permeable to allow the reaction process and exit of products, and solution permeable to deposit the catalysts). In another embodiment, one or more of the layers can contain an admixed compound which is chemically and thermally compatible with the primary compound. In a further embodiment, different layers can comprise different compounds that are chemically and electronically similar, and have about the same expansion coefficient. Each electrode layer preferably comprises the same contiguous electrolyte into which there is impregnated the active catalyst (or precursor from which the catalyst is derived). The catalysts in the different layers do not need to be the same. There can be different levels of loading of catalyst into the anode and cathode. More importantly, the anode and cathode can have catalysts of different nature. Preferably the cathode has a catalyst for activation of oxygen, for example a metal or LSM, and the anode has a catalyst for activation of ethane, for example a metal or a metal oxide.

Thus, based on these principles, in an embodiment, a ceramic membrane for a fuel cell may comprise a porous layer and a non-porous layer, in which the porous layer comprises a proton-conducting material or their mixtures, each proton-conducting material of the porous layer being a compound of the perovskite formula X1-X2-O_{3-δ} where X1=Ba, Sr or mixtures thereof and X2=Ce, Zr, Y, Nd, Yb, Sm, La, Hf, Pr or mixtures thereof and the non-porous layer comprises a second proton-conducting material or their mixtures, each second proton-conducting material of the non-porous layer being a compound of the perovskite formula X1-X2-O_{3-δ} where X1=Ba, Sr or mixtures thereof and X2=Ce, Zr, Y, Nd, Yb, Sm, La, Hf, Pr or mixtures thereof. The membrane may also comprise a second porous layer on an opposite side of the non-porous layer from the other porous layer, the second porous layer comprising a third proton-conducting material or their mixtures, each third proton-conducting material of the second non-porous layer being a compound of the perovskite formula X1-X2-O_{3-δ} where X1=Ba, Sr or mixtures thereof and X2=Ce, Zr, Y, Nd, Yb, Sm, La, Hf, Pr or mixtures thereof.

### REFERENCES CITED

[1] E. P. Murray, T. Tsai, S. A. Barnett, Nature 400 (1999) 649.
[2] T. Hibino, A. Hashimoto, T. Inoue, J. Tokuno, S. Yoshida, M. Sano, Science 288 (2000) 2031.
[3] Z. Shao, S. M. Haile, J. Ahn, P. D. Ronney, Z. Zhan, S. A. Barnett, Nature 435 (2005) 795.
[4] A. S. Bodke, D. A. Olschki, L. D. Schmidt, E. Ranzi, Science 285 (1999) 712.
[5] S. Y. Wang, J. L. Luo, A. R. Sanger, K. T. Chuang, J. Phys. Chem. C 111 (2007) 5069.
[6] Z. C. Shi, J. L. Luo, S. Y. Wang, A. R. Sanger, K. T. Chuang, J. Power Sources 176 (2008) 122.
[7] S. Barison, M. Battagliarin, T. Cavallin, L. Doubova, M. Fabrizio, C. Mortalo, S. Boldrini, L. Malavasi, R. Gerbasi, J. Mater. Chem. 18 (2008) 5120.
[8] C. Zuo, S. Zha, M. Liu, M. Hatano, M. Uchiyama, Adv. Mater. 18 (2006) 3318.
[9] R. R. Peng, Y. Wu, L. Z. Yang, Z. Q. Mao, Solid State Ionics 177 (2006) 389.
[10] J. M. Serra, O. Buechler, W. A. Meulenberg, H. P. Buchkremer, J. Electrochem. Soc. 154 (2007) B334.
[11] H. Matsumoto, I. Nomura, S. Okada, T. Ishihara, Solid State Ionics 179 (2008) 1486.
[12] L. Bi, S. Q. Zhang, S. M. Fang, L. Zhang, K. Xie, C. R. Xia, W. Liu, Electrochem. Commun. 10 (2008) 1005.
[13] K. Xie, R. Q. Yan, D. H. Dong, S. L. Wang, X. R. Chen, T. Jiang, B. Lin, M. Wei, X. Q. Liu, G. Y. Meng, J. Power Sources 179 (2008) 576.
[14] Y. M. Guo, Y. Lin, R. Ran, Z. P. Shao J. Power Sources 193 (2009) 400.
[15] T. Z. Wu, Y. Q. Zhao, R. R. Peng, C. R. Xia Electrochim. Acta 54 (2009) 4888.
[16] Y. H. Huang, R. I. Dass, Z. L. Xing, J. B. Goodenough, Science 312 (2006) 254.
[17] R. J. Gorte, S. Park, J. M. Vohs, C. Wang, Adv. Mater. 12 (2000) 1465.
[18] X. S. Xin, Z. Lu, Q. S. Zhu, X. Q. Huang, W. H. Su, J. Mater. Chem. 17 (2007) 1627.
[19] X. F Ye, S. R. Wang, Q. Hu, J. Y. Chen, T. L. Wen, Z. Y. Wen, Solid State Ionics 180 (2009) 276.
[20] D. Hirabayashi, A. Tomita, M. E. Brito, T. Hibino, U. Harada, M. Nagao and M. Sano, Solid State Ionics 168 (2004) 23.
[21] W. Tanner, K. Z. Fung, A. V. Virkar, J. Electrochem. Soc. 144 (1997) 21.
[22] Y. Feng, J. L. Luo, K. T. Chuang, J. Phys. Chem. C 112 (2008) 9943.
[23] D. W. Flick, M. C. Huff, J. Catal. 178 (1998) 315.
[24] Y. Azizi, C. Petit, V. Pitchon, J. Catal. 256 (2008) 338.
[25] M. Baerns, O. Buyevskaya, Catal. Today 45 (1998) 13-22.
[26] J. L. Luo, K. T. Chuang, A. R. Sanger, U.S. Patent, (2008) 20080152960.
[27] L. Bi, S. Q. Zhang, S. M. Fang, Z. T. Tao, R. R. Peng, W. Liu, Electrochem. Commun. 10 (2008) 1598-1601.
[28] X. T. Su, Q. Z. Yan, X. H. Ma, W. F. Zhang, C. C. Ge, Solid State Ionics 177 (2006) 1041-1045.
[29] K. Xie, Q. L. Ma, B. Lin, X. Q. Liu, G. Y. Meng, J. Power Sources 170 (2007) 38-41.
[30] M. D. Gross, J. M. Vohs, R. J. Gorte, J. Mater. Chem. 17 (2007) 3071-3077.
[31] T. L. Cable, S. W. Sofie, J. Power Sources 174 (2007) 221-227
[32] J. M. Vohs, R. J. Gorte, Adv. Mater. 21 (2009) 1-14.

1. A ceramic membrane for a fuel cell comprising:
a non-porous layer comprising a first proton-conducting material; and
a first porous layer adjacent to and contacting the non-porous layer along an interface, the first porous layer comprising a second proton-conducting material.

2. The ceramic membrane of claim 1 in which the first proton conducting material is the same material as the second proton conducting material.

3. The ceramic membrane of claim 1 in which the first proton conducting material and the second proton conducting material are sufficiently similar to avoid the interface providing resistance to the flow of ions across the interface.

4. The ceramic membrane of claim 1 in which the first proton-conducting material and the second proton conducting material each comprises a compound or mixture of compounds of the formula X1-X2-O_{3-δ} where X1=Ba, Sr or mixtures thereof and X2=Ce, Zr, Y, Nd, Yb, Sm, La, Hf, Pr or mixtures thereof.

5. The ceramic membrane of claim 1 further comprising a second porous layer adjacent to and contacting the non-porous layer along a second interface, the second porous layer comprising a third conducting material, the non-porous layer being situated between the first porous layer and the second porous layer.

6. The ceramic membrane of claim 5 in which the first proton conducting material is the same material as the second proton conducting material and the third proton conducting material is the same material as the first proton conducting material and the second proton conducting material.

7. The ceramic membrane of claim 5 in which the first proton conducting material and the third proton conducting material are sufficiently similar to avoid the interface providing resistance to the flow of ions across the interface.

8. The ceramic membrane of claim 5 in which each of the first proton-conducting material, the second proton-conducting material and the third proton-conducting material comprises a compound or mixture of compounds of the formula X1-X2-O_{3-δ} where X1=Ba, Sr or mixtures thereof and X2=Ce, Zr, Y, Nd, Yb, Sm, La, Hf, Pr or mixtures thereof.

9. The ceramic membrane of claim 1 in which the combined atomic ratio of Y, Nd, Yb, Sm and La to Ba and Sr in the first proton conducting material and in the second proton conducting material is between 0.1 and 0.3 inclusive.

10. The ceramic membrane of claim 1 in which the first proton-conducting material and the second proton-conducting material each comprises a compound of the formula X1-X2-X3-X4-O_{3-δ} where X1=Ba, Sr or mixtures thereof; X2=Ce; X3=Zr; X4=Y, Nd, Yb or Sm or mixtures thereof, and the atomic ratios of the elements are defined by X1=1, 0≦X2≦1, 0≦X3≦1, 0≦X4≦1 and X2+X3+X4=1.

11. The ceramic membrane of claim 1 in which the first proton-conducting material and the second proton-conducting material each comprises a compound of the formula BaCe₁₋ₓXₓO_{3-δ}, where Ba is barium, Ce is cerium, X is one of yttrium and lanthanum, x is a number in the range of 0.1≦x≦0.3.

12. The ceramic membrane of claim 1 in which the first proton-conducting material and the second proton-conducting material each comprises a compound of the formula BaCe_{1-x-y}X1ₓX2_{y}O_{3-δ}, where Ba is barium, Ce is cerium, X1 is one of yttrium and lanthanum, X2 is one of neodymium, zirconium and hafnium, x is a number in the range 0.1≦x≦0.3 and y is a number in the range 0≦y≦0.9.

13. The ceramic membrane of claim 1 in which the first proton-conducting material and the second proton-conducting material each comprises a compound of the formula BaCe₁₋ₓXₓO_{3-δ}, where Ba is barium, Ce is cerium, X is one of yttrium and lanthanum, x is a number in the range of 0.1≦x≦0.3.

14. The ceramic membrane of claim 12 in which the first proton-conducting material and the second proton-conducting material each comprises a compound of the formula BaCe_{1-x-y}X1ₓX2_{y}O_{3-δ}, where Ba is barium, Ce is cerium, X is one of yttrium and lanthanum, X2 is one of neodymium, zirconium and hafnium, x is a number in the range 0.1≦x≦0.3, y is a number in the range 0≦y≦0.9.

15. A process of manufacturing a ceramic membrane for a solid oxide fuel cell, comprising the steps of:
mixing a proton conducting ceramic in powder form with a pore-forming material;
pressing the mixture of the proton conducting ceramic and pore forming material to form a first layer;
pressing an additional quantity of the proton conducting ceramic in powder form adjacent to the first layer to form a second layer; and
sintering the first and second layers.

16. The process of claim 15 in which the proton conducting ceramic in powder form is produced by the steps of:
forming a solution in water of salts of metals or salts of metals complexed with destructable ligands, the anions of the salts being selected so that only the metal ions and oxide ions will remain after evaporation of the solution, and combustion and heat treatment of the residue left after evaporation;
adding a chelating agent to the solution;
adding an oxidant to the solution;
adding ammonia to the solution;
evaporating the water; and
igniting the residue left from the evaporation of the water to form a powder.

17. The process of claim 15 further comprising the step of impregnating the first layer with a catalyst after the step of sintering the first and second layers.

18. A process of manufacturing a ceramic membrane for a solid oxide fuel cell, comprising the steps of:
pressing a mixture of a proton conducting ceramic in powder form and a pore-forming material to form a first layer;
pressing an additional quantity of the proton conducting ceramic in powder form adjacent to the first layer to form a second layer;
pressing a mixture of a pore forming material and the proton conducting ceramic in powder form adjacent to the second layer to form a third layer; and
sintering the first, second and third layers.

19. The process of claim 18 in which the proton conducting ceramic in powder form is produced by the steps of:
forming a solution in water of salts of metals or salts of metals complexed with destructable ligands, the anions of the salts being selected so that only the metal ions and oxide ions will remain after evaporation of the solution, and combustion and heat treatment of the residue left after evaporation;
adding a chelating agent to the solution;
adding an oxidant to the solution;
adding ammonia to the solution;
evaporating the water; and
igniting the residue left from the evaporation of the water to form a powder.

20. The process of claim 18 further comprising the step of impregnating the first layer and the third layer with a catalyst after the step of sintering the first, second and third layers.

21. A solid oxide fuel cell comprising:
a ceramic membrane according to claim 1;
a first electrical connector connected to a first side of the ceramic membrane;
a second electrical connector connected to a second side of the ceramic membrane;
a conduit arranged to convey a hydrocarbon to the first side of the ceramic membrane;
a conduit arranged to convey oxidizer to the second side of the ceramic membrane;
a conduit arranged to convey a dehydrogenated hydrocarbon from the first side of the ceramic membrane; and
a conduit arranged to convey exhaust from the second side of the ceramic membrane.
